(19) United States
(12) Patent Application Publication
(10) Pub. No.: US 2019/0143903 A1
(43) Pub. Date: May 16, 2019

(54) CONSOLE ASSEMBLY, CONSOLE ASSEMBLY SYSTEM AND METHOD OF PRODUCING A CONSOLE ASSEMBLY

(71) Applicant: FORD GLOBAL TECHNOLOGIES, LLC, Dearborn, MI (US)

(72) Inventors: Siddharthan Selvasekar, Livermore, CA (US); Andres Almeida Senatore, Mountain View, CA (US); Daniel Boccuccia, San Francisco, CA (US)

(21) Appl. No.: 15/810,570

(22) Filed: Nov. 13, 2017

(51) Int. Cl. B60R 7/04; B60N 3/10

(52) U.S. Cl. CPC B60R 7/04; B33Y 10/00; B60N 3/101

(57) ABSTRACT

A console assembly includes a frame, having a plurality of module receivers, a plurality of modules held in the plurality of module receivers and a securing feature. The securing feature secures the plurality of modules in the plurality of modules receivers. A console assembly system allowing for the construction of a customized console assembly is also disclosed as is a related method of producing a console assembly.

### TECHNICAL FIELD

This document relates generally to the motor vehicle equipment field and, more particularly, to a new and improved console assembly, console assembly system and method of producing a console assembly.

### BACKGROUND

A center console of a motor vehicle is located between the driver and front passenger seats immediately aft of the center stack. In many motor vehicles, the center console interacts with vehicle mechanical systems such as the hand brake/e-brake and/or the gear shifting lever or knob. It is also a location utilized by occupants to store personal belongings or, in the case of police enforcement vehicles, utilized to house various operating systems such as radio and computer systems that must be conveniently accessed by a law enforcement official.

This document relates to a new and improved console assembly including a frame having a plurality of module receivers adapted to receive a plurality of different modules having different configurations and design functions. Such a console assembly may be incorporated into a console assembly system wherein particular modules are selected and mounted within the frame so as to customize the console assembly to the preferences, needs and/or desires of the ultimate motor vehicle operator. Further, this document relates to a new and improved method of producing a console assembly with a unique system for integrating modules within the lightweight frame of the console assembly.

### SUMMARY

In accordance with the purposes and benefits described herein, a new and improved console assembly is provided. That console assembly comprises (a) a frame, including a plurality of module receivers, (b) a plurality of modules held in the plurality of module receivers and (c) a securing feature. The securing feature secures the plurality of modules in the plurality of module receivers. The securing feature includes (a) a first set of magnet elements held in a plurality of magnet element receivers enveloped by the frame and (b) a cooperating second set of magnet elements carried on the plurality of modules.

The frame may include a first side lattice, a second side lattice and a plurality of cross supports. The plurality of cross supports form bottom walls of the plurality of module receivers. The entire frame, including the first side lattice, the second side lattice and the plurality of cross supports may be made as a single integral, one-piece component part. The plurality of magnet element receivers may be provided in the plurality of cross supports.

In accordance with an additional aspect, a console assembly system is provided. That console assembly system comprises (a) a frame including a plurality of module receivers, (b) a plurality of different modules adapted to be held in the plurality of module receivers and (c) a securing feature. The securing feature secures selected modules of the plurality of different modules in the plurality of module receivers whereby the frame may be built in a number of different configurations allowing customization to customer preferences and desires.

The securing feature may include (a) a first set of magnet elements held in a plurality of magnet element receivers enveloped by the frame and (b) a cooperating second set of magnet elements carried on the plurality of modules.

The frame may include a first side lattice, a second side lattice and a plurality of cross supports. The plurality of cross supports may form bottom walls of the plurality of module receivers. The plurality of magnet element receivers may be provided in the plurality of cross supports.

The plurality of different modules may be selected from a wide ranging group of modules including but not necessarily limited to storage compartment modules, cup holder modules, electronic systems modules for any appropriate electronic operating system such as a radio communication system, computer, information display or the like, waste bin, hook attachments, speaker system, water dispenser, sanitation dock, cooler, military gear storage, conferencing tools, mini-dryer, open bin, cupholders (single, double, triple) with all permutations including a phone port, device dock (with USB-C, micro USB, lightning port), dispatch radio, siren control, laptop mount, single-DIN and double-DIN equipment slots, floating armrest, lockbox, machine equipment control (construction, crane, etc.), rear facing TV, rear facing charging port, stowable tables (like an airplane) and combinations thereof.

In accordance with an additional aspect, a method of producing a console assembly is provided. That method comprises the steps of: (a) three-dimensional (3D) printing a first portion of a frame including at least part of a first magnet element receiver having a first side wall, (b) pausing 3D printing and inserting a first magnet element into the first magnet element receiver and (c) 3D printing a second portion of the frame including a remainder of the first magnet element receiver whereby the first magnet element is enveloped by the first portion and the second portion of the frame.

The method may further include the step of inserting a first module into a first module receiver formed in the frame. This may include the step of nesting the first module into the first module receiver formed in the frame.

The method may also include the step of aligning a second magnet element carried on the first module with the first magnet element enveloped by the frame whereby the first magnet element and the second magnet element are attracted together to secure the first module in the first module receiver.

The method may further include the additional step of inserting a second module into a second module receiver formed in the frame. This may include the step of nesting the second module into the second module receiver formed in the frame. Further, this may include the step of aligning a third magnet element carried on the second module with a fourth magnet element enveloped by the frame whereby the third magnet element and the fourth magnet element are attracted together to secure the second magnet module in the second module receiver.

Still further, the method may include the step of inserting a third module into a third module receiver formed in the frame. This may include the step of nesting the third module into the third module receiver formed in the frame. Further, this may include the step of aligning a fifth magnet element carried on the third module with a sixth magnet element enveloped by the frame whereby the fifth magnet element and the sixth magnet element are attracted together to secure the third module in the third module receiver.

In the following description, there are shown and described several preferred embodiments of console assembly, consoles assembly system and method of producing a console assembly. As it should be realized, the console assembly, the console assembly system and the method are capable of other, different embodiments and their several details are capable of modification in various, obvious aspects all without departing from the console assembly, console assembly system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the console assembly, console assembly system and method of producing a console assembly and together with the description serve to explain certain principles thereof.

FIG. 1 is a partially exploded perspective view of the new and improved console assembly illustrating the frame and the plurality of modules held in the frame.

FIGS. 2a-2c are a series of views illustrating how a first magnet is enveloped within the frame during the manufacturing process.

FIGS. 3a-3c schematically illustrate the installation of respective first, second and third modules in respective first, second and third module receivers formed in the frame during the manufacturing process.

Reference will now be made in detail to the present preferred embodiments of the console assembly, console assembly system and method of producing a console assembly, examples of which are illustrated in the accompanying drawing figures.

### DETAILED DESCRIPTION

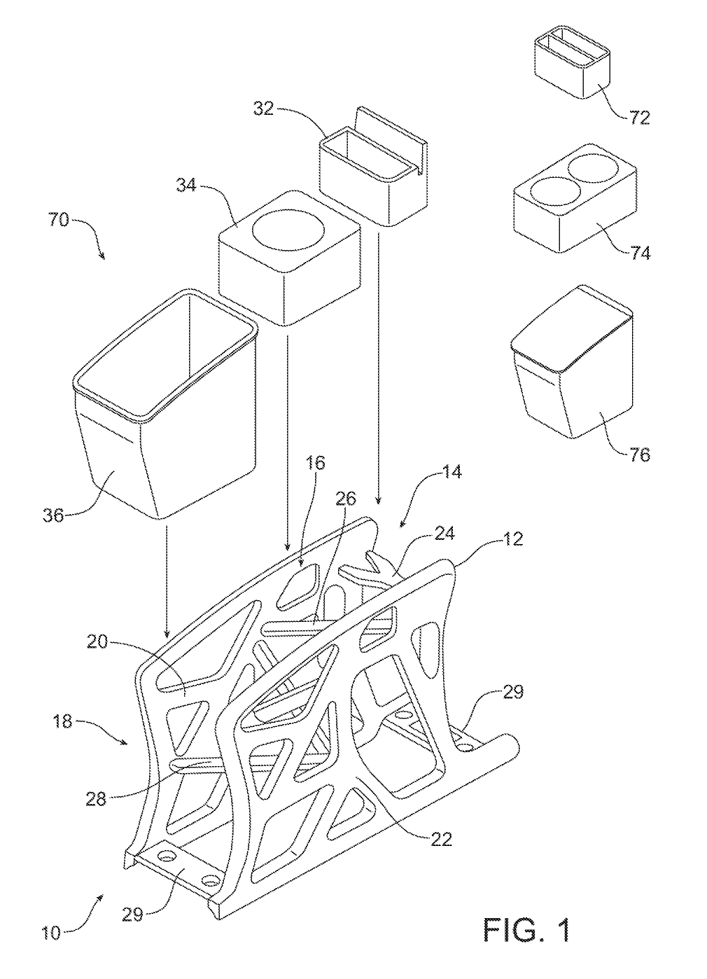

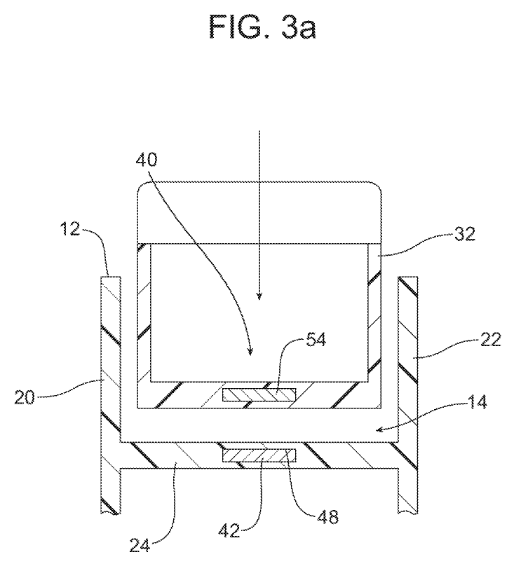

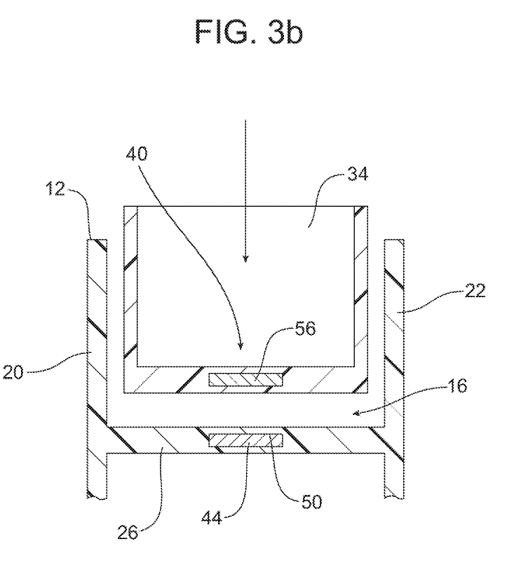

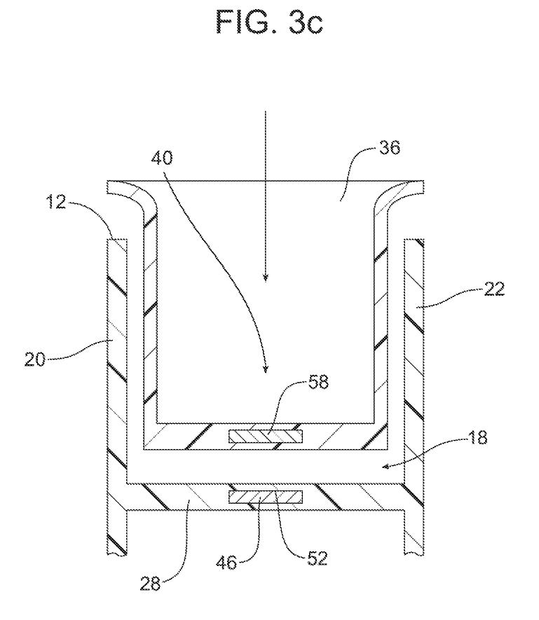

Reference is now made to FIGS. 1 and 3a-3c which illustrate the new and improved console assembly 10. That console assembly 10 includes a frame 12 having a plurality of module receivers, which in the illustrated embodiment, include a first module receiver 14, a second module receiver 16 and a third module receiver 18.

More specifically, the frame 12 includes a first side lattice 20, a second side lattice 22 and a plurality of cross supports, which in the illustrated embodiment include a first cross support 24, a second cross support 26 and a third cross support 28. Also note cross members 29 that function as brackets for security mounting the frame 12 to the floor pan of a motor vehicle.

The frame 12 may be made using additive manufacturing or 3D printing technology. Thus, it should be appreciated that the entire frame 12 may be made/molded as a single integrated structure. Thus, the first side lattice 20, the second side lattice 22, the first cross support 24, the second cross support 26 and the third cross support 28 may be made as a single piece.

The console assembly 10 also includes a plurality of modules. In the illustrated embodiment, the plurality of modules includes the first module 32, the second module 34 and the third module 36. In the illustrated embodiment, the first module 32, the second module 34, and the third module 36 are all different. Here it should be appreciated that two or more of the modules 32, 34, 36 may be the same if desired to meet the preference of a customer purchasing a motor vehicle equipped with the console assembly 10. It should also be appreciated that the depicted modules 32, 34, 36 are only exemplary of three possible modules and are not limiting in scope.

The console assembly 10 also includes a securing feature generally designated by reference numeral 40. In the illustrated embodiment, the securing feature 40 secures the first module 32 in the first module receiver 14, the second module 34 in the second module receiver 16 and the third module 36 in the third module receiver 18. See FIG. 3a illustrating the securing of the first module 32 in the first module receiver 14, FIG. 3b illustrating the securing of the second module 34 in the second module receiver 16 and FIG. 3c illustrating the securing of the third module 36 in the third module receiver 18.

More specifically, in the illustrated embodiment, the securing feature 40 includes a first set of magnet elements 42, 44, 46 held in a plurality of magnet element receivers 48, 50, 52 enveloped by the frame 12 and a cooperating second set of magnet elements 54, 56, 58 carried on the plurality of modules 32, 34, 36.

More specifically, in the illustrated embodiment, the magnet element 42 is enveloped in the magnet element receiver 48 in the first cross support 24 of the frame 12. Magnet element 44 is enveloped in the magnet element receiver 50 in the second cross support 26 of the frame 12. The magnet element 46 is enveloped in the magnet element receiver 52 in the third cross support 28 of the frame 12. Here it should be appreciated that the magnet element receiver 48, 50, 52 may be provided in any part of the frame 12 and not just the cross supports 24, 26, 28 as shown. The second set of magnet elements 54, 56, 58 may be carried on any part of the modules 32, 34, 36. All that is required is that the two sets of magnets 42, 44, 46 and 54, 56, 58 substantially align where the modules 32, 34, 36 are fully seated in the frame 12 in order to reduce or eliminate potential for the modules to shift.

The magnet element 54 is carried on or embedded in the first module 32. The magnet element 56 is carried on or embedded in the second module 34. The magnet element 58 is carried on or embedded in the third module 36.

For purposes of this document, the terminology “magnet element” means any material capable of producing magnetic attraction with another ferromagnetic element, including magnetic, paramagnetic and ferromagnetic materials as well as electromagnets.

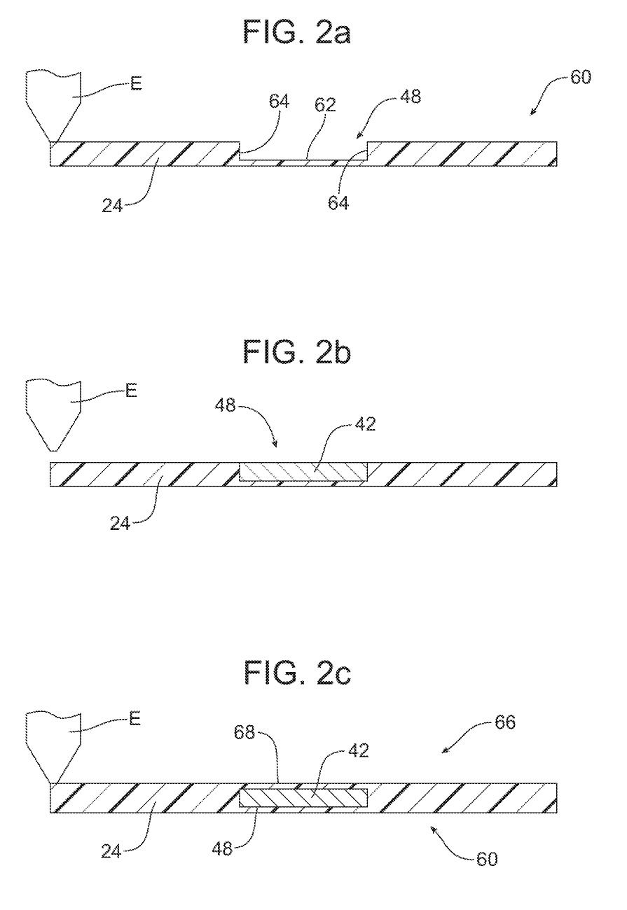

As previously noted, the console assembly 10 and, more particularly, the frame 12 of the console assembly 10 may be manufactured utilizing additive manufacturing or 3D printing techniques. Accordingly, a method of producing the console assembly 10 may comprise the steps of 3D printing a first portion 60 of the frame 12 including at least one part of the first magnet element receiver 48. As illustrated in FIG. 2a that part of the first magnet element receiver 48 includes a first end wall 62 and a first side wall 64. Note the extruder E utilized to 3D print the first portion 60.

As illustrated in FIG. 2b, next the method includes the step of pausing 3D printing (note extruder E withdrawn from the first portion 60 of the frame 12) and inserting the first magnet element 42 in the first magnet element receiver 48. Note particularly how the first magnet element 42 nests in the first magnet element receiver 48 which has been printed to match the size and shape of the first magnet element.

Next, as illustrated in FIG. 2c, the method includes the step of 3D printing a second portion 66 of the frame 12 including a remainder of the first magnet element receiver 48 (note second end wall 68) whereby the first magnet element 42 is fully enveloped and surrounded by the first portion 60 and second portion 66 of the frame 12.

Magnet element 44 is enveloped in the second cross support 26 of the frame 12 in the same manner the magnet element 42 is enveloped in the first cross support 24 of the frame 12. Similarly, magnet element 46 is also enveloped in the third cross support 28 of the frame 12 in the same way.

After 3D printing the entire frame 12, the method includes the step of inserting the first module 32 into the first module receiver 14 formed in the frame 12 (see FIG. 3a). As illustrated in FIG. 3a, this includes the step of nesting the first module 32 into the first module receiver 14 formed in the frame 12 by the first side lattice 20, the second side lattice 22 and the first cross support 24. Further, it should be appreciated that the inserting of the first module 32 in the first module receiver 14 includes aligning the second magnet element 54 carried on the first module 32 with the first magnet element 42 enveloped in the first cross support 24 of the frame 12. When the first module 32 is fully nested and seated within the first module receiver 14, the first magnet element 42 and the second magnet element 54 are aligned and sufficiently close together to be attracted together and thereby secure the first module 32 in the first module receiver 14. The positive retention force provided by the cooperating first and second magnet elements 42, 54 serves to substantially reduce or eliminate the potential for the first module 32 moving and/or rattling in the first module receiver 14.

As illustrated in FIG. 3b, the method may also include the step of inserting the second module 34 into the second module receiver 16. This includes nesting the second module 34 into the second module receiver 16 formed in the frame 12 by the first side lattice 20, the second side lattice 22 and the second cross support 26. Toward this end, the fourth magnet element 56 carried on the second module 34 is aligned with the third magnet element 44 enveloped in the second cross support 26 of the frame 12. When the second module 34 is fully nested and seated within the second module receiver 16, the third magnet element 44 and the fourth magnet element 56 are aligned and sufficiently close together to be attracted together and thereby secure the second module 34, movement free/rattle free, in the second module receiver 16.

As illustrated in FIG. 3c, the method may also include the step of inserting the third module 36 into the third module receiver 18. This includes nesting the third module 36 into the third module receiver 18 formed in the frame 12 by the first side lattice 20, the second side lattice 22 and the third cross support 28. Toward this end, the sixth magnet element 58 carried on the third module 36 is aligned with the fifth magnet element 46 enveloped in the third cross support 28 of the frame 12. When the third module 36 is fully nested and seated within the third module receiver 18, the fifth magnet element 46 and the sixth magnet element 58 are aligned and sufficiently close together to be attracted together and thereby secure the third module 36, movement free/rattle free, in the third module receiver 18.

As should be appreciated, the console assembly 10 may be utilized in a console assembly system 70 that includes a wide ranging and large number of different modules adapted to be held in the plurality of module receivers 14, 16, 18. The plurality of different modules may be selected from a group of modules including, but not necessarily limited to waste bin, hook attachments, speaker system, water dispenser, sanitation dock, cooler, military gear storage, conferencing tools, mini-dryer, open bin, cupholders (single, double, triple) with all permutations including a phone port, device dock (with USB-C, micro USB, lightning port), dispatch radio, siren control, laptop mount, single-DIN and double-DIN equipment slots, floating armrest, lockbox, machine equipment control (construction, crane, etc.), rear facing TV, rear facing charging port, stowable tables (like an airplane) and combinations thereof.

For example, as illustrated in FIG. 1, the first module 32, the second module 34 and the third module 36 are selected and mounted in the respective first, second and third module receivers 14, 16, 18 of the frame 12 from a larger group of modules including additional modules 72, 74, and 76. By individually selecting the modules 32, 34, 36 secured in the frame 12, it is possible to build a console assembly 10 in a number of different configurations including a configuration customized to the needs and desires of any particular operator of a motor vehicle equipped with the console assembly 10. Thus, the console assembly system 70 provides incredible versatility, allowing one to construct a console assembly 10 meeting wide ranging needs and desires of customers and purchasers of motor vehicles including across multiple motor vehicle models. As should be appreciated, the versatility and potential customization of the console assembly 10 enhances customer satisfaction while at the same time reducing overall manufacturing costs.

The foregoing has been presented for purposes of illustration and description. It is not intended to be exhaustive or to limit the embodiments to the precise form disclosed. Obvious modifications and variations are possible in light of the above teachings. For example, one or more of the modules 32, 34, 36, 72, 74, 76 may be made by additive manufacturing or 3D printing. It should also be appreciated that, while not shown, a trim cover may be provided over the frame 12 if desired. Still further, the first set of magnet elements 42, 44, 46 in the frame 12 may be electromagnets configured or adapted to be activated when the motor vehicle ignition is turned on. This would allow for easy removal and replacement of modules 32, 34, 36, 72, 74, 76 when the vehicle is off. All such modifications and variations are within the scope of the appended claims when interpreted in accordance with the breadth to which they are fairly, legally and equitably entitled.

What is claimed:

1. A console assembly, comprising:
a frame including a plurality of module receivers;
a plurality of modules held in said plurality of module receivers; and
a securing feature securing said plurality of modules in said plurality of module receivers, said securing feature including (a) a first set of magnet elements held in a plurality of magnet element receivers enveloped by said frame and (b) a cooperating second set of magnet elements carried on said plurality of modules.

2. The console assembly of claim 1 wherein said frame includes a first side lattice, a second side lattice and a plurality of cross supports, said plurality of cross supports forming bottom walls of said plurality of module receivers.

3. The console assembly of claim 2, wherein said plurality of magnet element receivers are in said plurality of cross supports.

4. A console assembly system, comprising:
a frame including a plurality of module receivers;
a plurality of different modules adapted to be held in said plurality of module receivers; and
a securing feature securing selected modules of said plurality of different modules in said plurality of module receivers whereby a console assembly may be built in a number of different configurations.

5. The console assembly system of claim 4 wherein said securing feature includes (a) a first set of magnet elements held in a plurality of magnet element receivers enveloped by said frame and (b) a cooperating second set of magnet elements carried on said plurality of modules.

6. The console assembly system of claim 5, wherein said frame includes a first side lattice, a second side lattice and a plurality of cross supports, said plurality of cross supports forming bottom walls of said plurality of module receivers.

7. The console assembly system of claim 6, wherein said plurality of magnet element receivers are in said plurality of cross supports.

8. The console assembly system of claim 7, wherein said plurality of different modules are selected from a group of modules consisting of waste bin, hook attachments, speaker system, water dispenser, sanitation dock, cooler, military gear storage, conferencing tools, mini-dryer, open bin, cupholders (single, double, triple) with all permutations including a phone port, device dock (with USB-C, micro USB, lightning port), dispatch radio, siren control, laptop mount, single-DIN and double-DIN equipment slots, floating armrest, lockbox, machine equipment control (construction, crane, etc.), rear facing TV, rear facing charging port, stowable tables (like an airplane) and combinations thereof.

9. A method of producing a console assembly, comprising:
3D printing a first portion of a frame including at least a part of a first magnet element receiver;
pausing 3D printing and inserting a first magnet element into said first magnet element receiver; and
3D printing a second portion of said frame including a remainder of said first magnet element receiver whereby said first magnet element is enveloped by said first portion and said second portion of said frame.

10. The method of claim 9, including inserting a first module into a first module receiver formed in said frame.

11. The method of claim 10, including nesting said first module into said first module receiver formed in said frame.

12. The method of claim 11, including aligning a second magnet element carried on said first module with said first magnet element enveloped by said frame whereby said first magnet element and said second magnet element are attracted together to secure said first module in said first module receiver.

13. The method of claim 12, including inserting a second module into a second module receiver formed in said frame.

14. The method of claim 13, including nesting said second module into said second module receiver formed in said frame.

15. The method of claim 14, including aligning a third magnet element carried on said second module with a fourth magnet element enveloped by said frame whereby said third magnet element and said fourth magnet element are attracted together to secure said second module in said second module receiver.

16. The method of claim 15 including inserting a third module into a third module receiver formed in said frame.

17. The method of claim 16, including nesting said third module into said third module receiver formed in said frame.

18. The method of claim 17, including aligning a fifth magnet element carried on said third module with a sixth magnet element enveloped by said frame whereby said fifth magnet element and said sixth magnet element are attracted together to secure said third module in said third module receiver.
